(19) United States
(12) Patent Application Publication
(10) Pub. No.: US 2005/0206531 A1
(43) Pub. Date: Sep. 22, 2005

(54) Portable system for detection and management of road traffic and environmental conditions

(76) Inventor: Rene Noel, Val Joli (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/037,336

(22) Filed: Jan. 19, 2005

(30) Foreign Application Priority Data
Jan. 19, 2004 (CA) 2,454,508

(51) Int. Cl. G08G 1/01

(52) U.S. Cl. 340/936; 340/539.26

(57) ABSTRACT

A system is provided to detect road traffic conditions and environmental conditions. The system having a detection apparatus for detecting and managing road traffic conditions and environmental conditions at a surveillance site, and for interpreting information collected, and for instance, simulate local surveillance. A telecommunications device is connected to the detection apparatus so as to transmit data to a remote server. The remote server receives data from the detection apparatus and is accessible to provide the data collected by the detection apparatus. A method for signaling speed derogations to a vehicle driver in road traffic. The method comprises the steps of: i) monitoring a road to detect movement caused by a vehicle; ii) measuring a speed of the vehicle detected in step i); and iii) signaling a warning if the speed is above a given value.

### CROSS-REFERENCE TO RELATED APPLICATION

This patent application claims priority on Canadian Patent Application No. 2,454,508, filed on Jan. 19, 2004, by the present applicant.

### BACKGROUND OF THE INVENTION

1. Field of the Invention

The present invention relates to road surveillance for vehicle speed derogations and, more particularly, to a portable detection system and apparatus for road traffic and environmental conditions.

2. Background Art

Due to the cost of maintaining adequate road surveillance staffing, many road segments are without surveillance. There are various problems associated with a lack of speed derogation/infraction prevention, such as repeatability of derogations.

It has been observed that the simulation of surveillance causes the vehicle drivers to slow down to the speed limit, to avoid being caught speeding (and avoid associated penalties, such as fines and notices in police records).

In order to prevent accidents, for instance on road construction sites, and in order to reduce the speed of drivers, police patrols and electronic speed displays are often used. Police patrols often cannot be used for 24-hour period, as this represents a costly solution.

As for electronic speed display devices, the drivers often do not have sufficient time to observe the display. Moreover, such display devices have become commonplace, whereby they have little influence on the behavior of the drivers.

### SUMMARY OF INVENTION

It is therefore an aim of the present invention to provide a novel portable detection system and apparatus for road traffic surveillance.

It is a further aim of the present invention that the novel detection system be used to collect environmental conditions and other surrounding information.

It is a still further feature of the present invention to provide a method for simulating road surveillance in response to the detection of speed derogations.

Therefore, in accordance with the present invention, there is provided a method for signaling speed derogations to a vehicle driver in road traffic, comprising the steps of: i) monitoring a road to detect movement caused by a vehicle; ii) measuring a speed of the vehicle detected in step i); and iii) signaling a warning if the speed is above a given value.

Further in accordance with the present invention, there is provided a system for detecting road traffic conditions and environmental conditions, comprising: at least one detection apparatus comprising sensors for detecting any one of road traffic conditions and environmental conditions, the at least one detection apparatus being adapted to be located at a surveillance site, the at least one detection apparatus having a processing unit so as to interpret information collected by any one of the sensors; a telecommunications device connected to the apparatus so as to transmit data interpreted by the at least one detection apparatus to a remote server; and the remote server for receiving said data from the at least one detection apparatus, the remote server being accessible to provide the data collected by the at least detection apparatus.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a perspective view of a detection apparatus in accordance with a preferred embodiment of the present invention, with a door thereof closed;

FIG. 2 is a perspective view of the detection apparatus of FIG. 1, with a door open to show the interior of the detection apparatus;

FIG. 3 is a block diagram illustrating a detection system in accordance with a preferred embodiment of the present invention;

FIG. 4 is a flowchart illustrating a method for signaling a speed derogation in accordance with the preferred embodiment of the present invention;

FIG. 5 is a flowchart illustrating an image-taking method in accordance with the present invention;

FIG. 6 is a flowchart illustrating a method for taking environmental condition measurements in accordance with the present invention;

FIG. 7 is a flowchart illustrating a method for transferring data to the server with the detection system of the present invention;

FIG. 8 is a schematic view of a web page representing a map upon which are positioned detection apparatuses in accordance with the present invention; and

FIGS. 9 to 11 are schematic views illustrating web pages presenting data collected using the detection system of the present invention.

### DESCRIPTION OF THE PREFERRED EMBODIMENTS

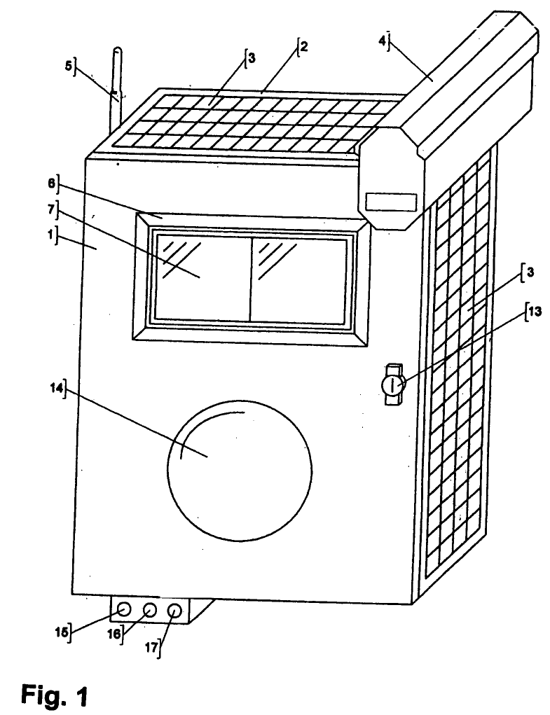

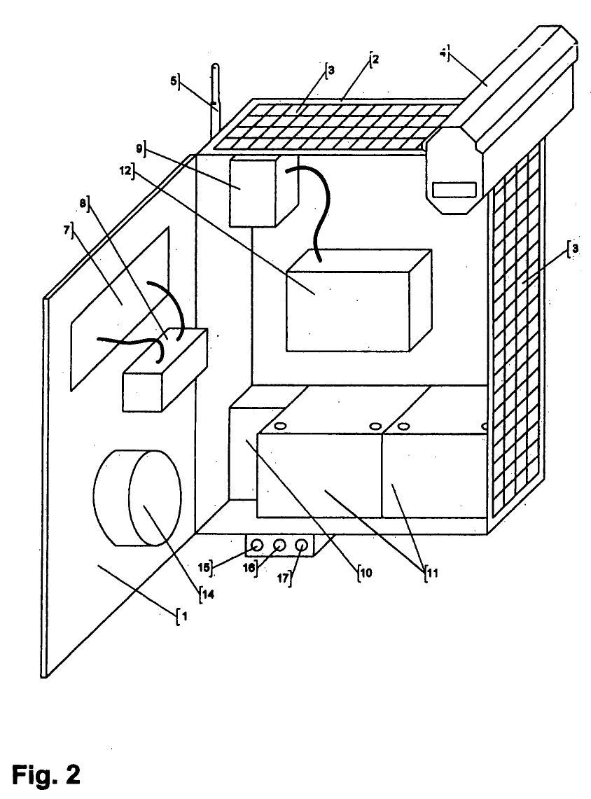

Referring to the drawings, and more particularly to FIGS. 1 and 2, a detection apparatus in accordance with a preferred embodiment of the present invention is generally shown at A. The detection apparatus A has a casing 2 which accommodates various components of the detection apparatus A. A door 1 conceals in a waterproof way the components within the casing 2. In FIG. 1, the door 1 is shown closed, whereas in FIG. 2 an interior of the casing 2 is shown with the door 1 being open.

The casing 2 is typically of a metallic material that is sealed in a waterproof manner so as to resist atmospheric conditions. A lock 13 is provided so as to lock the door 1, and substantially prevent tampering of the components within the casing 2.

A plurality of components are provided on an exposed surface of the casing 2. For instance, solar panels 3, a radar 4, an antenna 5, a strobe light 7 and its support 6, as well as a surveillance camera 14, are all on an outer surface of the casing 2. Moreover, various types of sensors, such as a temperature sensor 15, a humidity sensor 16, and a gas sensor 17, are also provided on an outer surface of the casing 2.

The components within the casing 2 are as follows. A power supply regulator 8 is provided within the casing 2 and is connected to the strobe light 7 so as to supply the strobe light 7 with the appropriate power. A modem 9 is connected to the antenna 5 (e.g., for cellular communications), and is wired to a processing unit 12 of the casing 2. A battery charger and/or voltage regulator for local power supply is shown at 10, and is connected to batteries 11. The detection apparatus A is powered by the batteries 11 or by the local supply by way of the voltage regulator 10, so as to provide suitable voltage to the various components of the detection apparatus A. The batteries 11 are recharged by the solar panels 3. It is pointed out that the solar panels 3 are preferably positioned on the sides and the top of the detection apparatus A (but could be separated from the casing 2) so as to maximize the exposure to light and increase the possibility of orientation of the detection apparatus A. Accordingly, the detection apparatus A may be autonomous with regard to power consumption if no local power port is available.

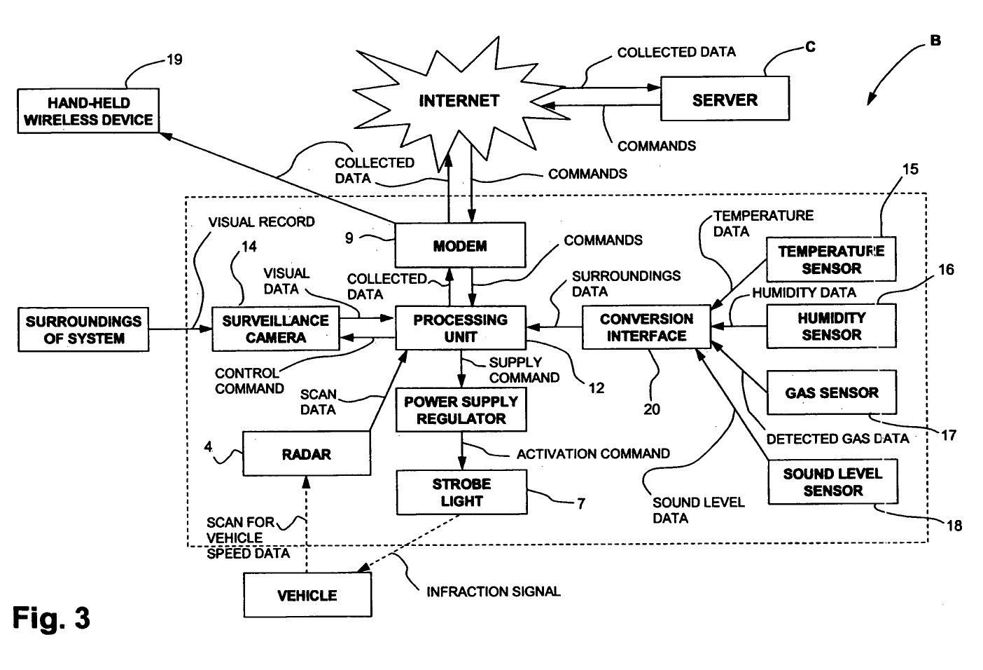

Referring to FIG. 3, the detection system in accordance with the present invention is generally shown at B. The detection system A has the detection apparatus A.

A processor unit 12 is used to control the operation of the detection apparatus A. The processor unit 12 has suitable ports so as to be connected to the various components within the detection apparatus A, such as the radar 4 (e.g., a hyper frequency radar, laser radar or the like), the strobe light 7 through the power supply regulator 8, the modem 9, as well as the temperature sensor 15, the humidity sensor 16 and the gas sensor 17. Moreover, the detection apparatus A may also be provided with a sound level sensor 18, so as to provide additional information pertaining to the sound level in the surroundings of the detection apparatus A. This is advantageously used to measure the sound level of freight carriers.

The processing unit 12 of the detection apparatus A is connected to the radar 4, so as to obtain data from the radar 4. Therefore, the radar 4 can be used to detect speed derogations, by the processing unit 12 interpreting the data from the radar 4.

The processing unit 12 is also connected to the strobe light 7 by way of the power supply regulator 8, such that a speed derogation detected by the processing unit 12 (from the scan data provided by the radar 4), can be signaled as a derogation signal through the light 7. Alternatively, a rotating light, also simulating a derogation signal, can be used to warn the driver of the derogation.

The processing unit 12 is also connected to other components, as described previously. For instance, the surveillance camera 14 is provided in the detection apparatus A, so as to visually record the surroundings of the system B. For instance, road conditions (e.g., presence of snow, ice or the like on the pavement) and other associated visual information, as well as statistical data is recorded by the surveillance camera 14. Moreover, the vehicle identification can be recorded in response to a speed derogation detection by the processing unit 12. The power supply regulator 8 is typically wired to the processing unit 12 via the digital port of the interface card. The surveillance camera 14 is typically connected to the processing unit 12 by way of a video port, integrated to the mother board. The various sensors, such as the temperature sensor 15, the humidity sensor 16, and the gas sensor 17, are typically connected to the conversion interface 20 by way of digital ports.

Referring to FIGS. 1, 2 and 3, the environmental conditions sensors (i.e., temperature sensor 15, humidity sensor 16 and gas sensor 17) are connected to the processing unit 12 via the conversion interface 20 so as to provide the processing unit 12 with environmental conditions. For instance, levels of noxious gases are monitored by way of the gas sensor 17, and high levels of such gases can be detected by the processing unit 12.

Therefore, the processing unit 12 gathers various types of information, which can prompt on site intervention from the detection apparatus A (e.g., derogation signal by the strobe light 7 to simulate police presence). Alternatively, the information gathered by the detection apparatus A may be transmitted to an off site server C, by way of the internet D, as will be explained hereinafter. It is contemplated to provide the detection apparatus A with cellular communication, by adapting the detection apparatus A to local cellular networks.

Alternatively, it is contemplated to use the detection apparatus A to communicate the collected data to nearby surveillance personnel. More specifically, the modem 9 can transfer the data to a hand-held wireless device 19, such that a surveillance officer standing near to the detection apparatus A can intervene in response to readings obtained by the hand-held wireless device 19 if there are infractions or derogations in the measured values (e.g., speed limit derogations, significantly high sound levels measured). It is contemplated to used a RF modem and RF communications between the detection apparatus A and the hand-held wireless device 19.

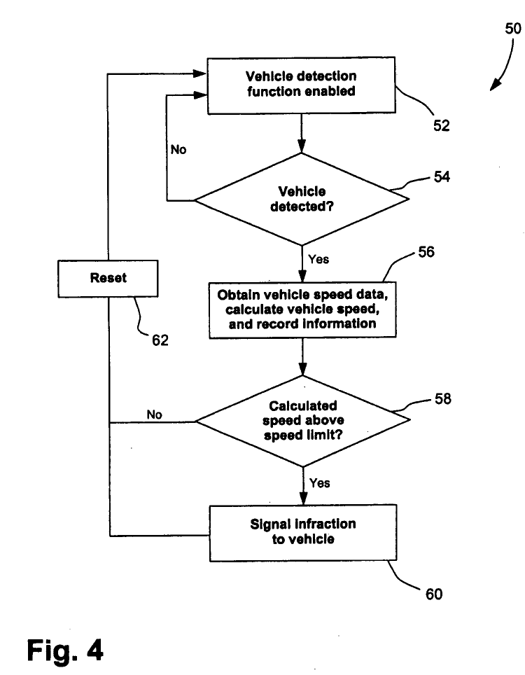

Referring to FIG. 4, a method used by the detection system B of the present invention is generally shown at 50.

In Step 52, the road is scanned for the presence of vehicles if the vehicle detection function is enabled for the processing unit 12 of the detection apparatus A. More specifically, the vehicle detection function is performed jointly by the radar 4 and the processing unit 12, with the radar 4 detecting the presence of any vehicle on the road that is scanned, and transmitting the scan data to the processing unit 12.

In Decision 54, a vehicle detected will bring the detection apparatus A to Step 56. Otherwise, the detection apparatus A will keep on scanning the road until a vehicle is detected, or until the vehicle detection function is disabled.

In Step 56, once the radar signals the presence of a vehicle to the processing unit 12, vehicle speed data and other information are obtained. Moreover, the vehicle speed is calculated and the information is recorded along with statistical data. For instance, in addition to the vehicle speed, the time and images of the vehicle are gathered. The size (i.e., length) of the vehicle may also be calculated from the scanned data of the radar 4. An average speed for the last few vehicles may also be calculated.

In Decision 58, the calculated vehicle speed is compared to the speed limit or other suitable speed parameter (such as an average speed). If the calculated speed is above the speed limit, the method goes to Step 60. Otherwise, the method will go to Step 62.

In Step 60, if the calculated speed is above the speed limit, the derogation is signaled to the vehicle driver. This is performed by the use of the strobe light 7 or other suitable lighting source. In order to try to cause the vehicle driver to slow down, the detection apparatus A and its strobe light 7 are turned on when the vehicle is still at a substantial distance from the detection apparatus A, so as to simulate the presence of a police vehicle. By simulating the presence of a police vehicle, the vehicle driver will have a tendency to slow down.

In Step 62, the detection apparatus A is reset for a subsequent vehicle.

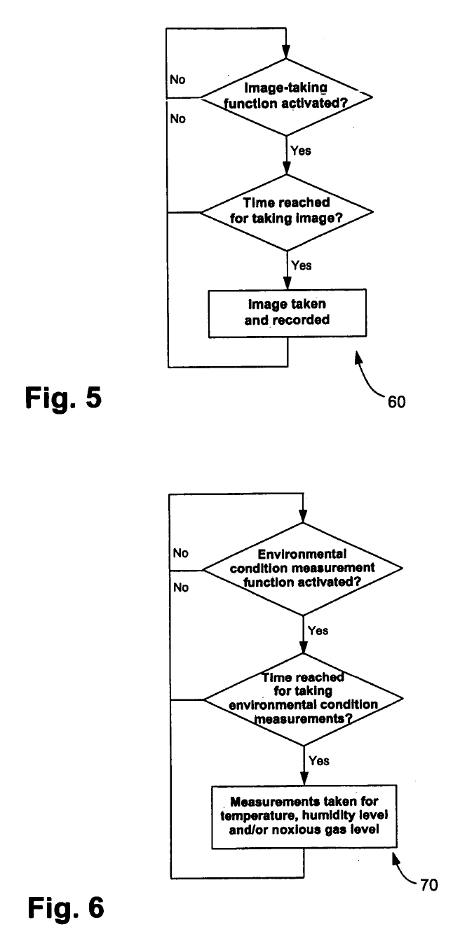

In FIG. 5, a method for regulating the image-taking picture of the detection apparatus A is generally illustrated at 60.

In FIG. 6, a function for activating the periodic environmental condition measurement function for detection apparatus A is generally illustrated at 70.

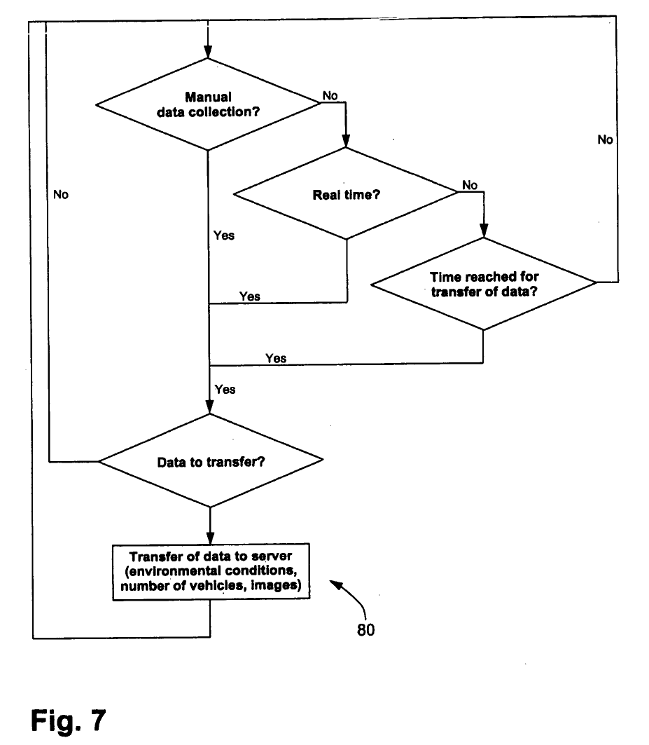

In FIG. 7, a method for transferring information collected by the detection apparatus A to a server is generally illustrated at 80.

In addition to preventing and diminishing the risk of accidents due to speed, the detection system B in accordance with the present invention will, by way of its data acquisition configuration and its mobility, allow a better understanding of the road behavior of drivers. The collection of data (the number of vehicles, types of vehicles, the speed, the time values, and other factors) and management of this data are performed remotely towards a server in an efficient and low-cost way. Moreover, this can be performed continuously over 24 hours.

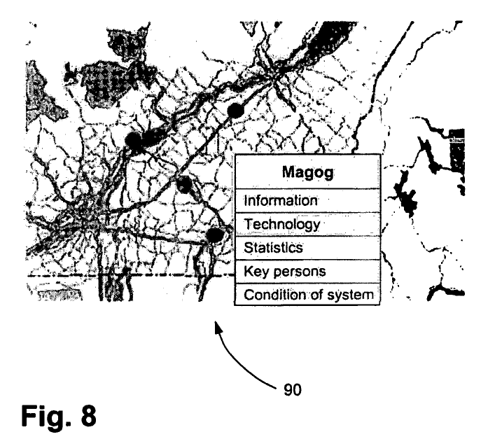

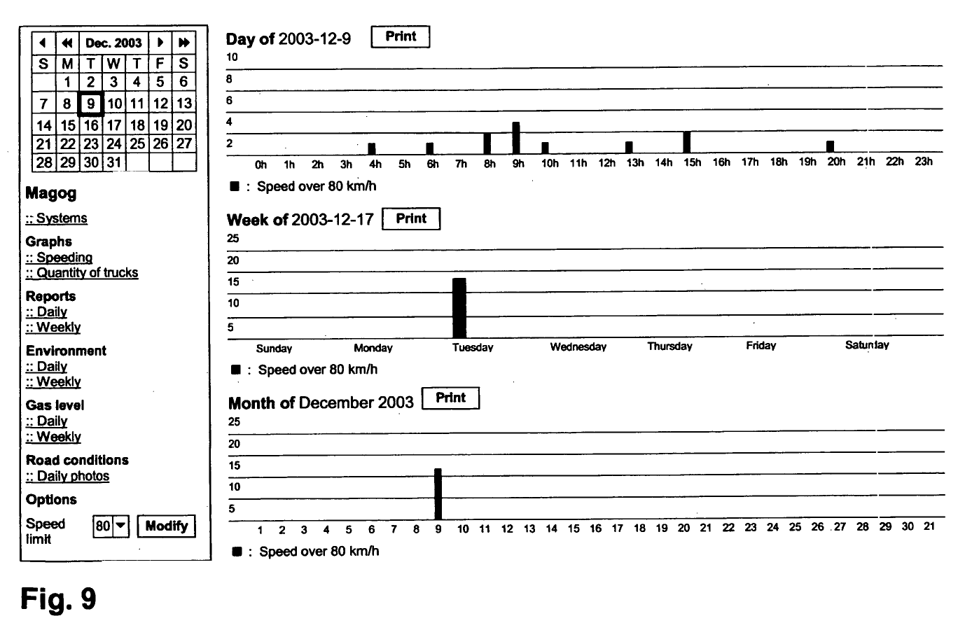

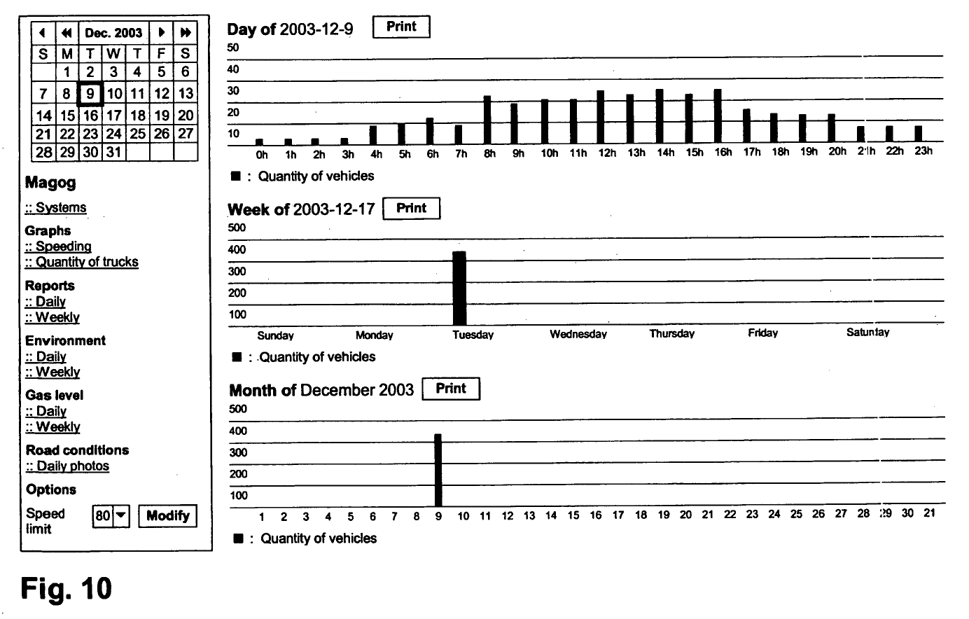

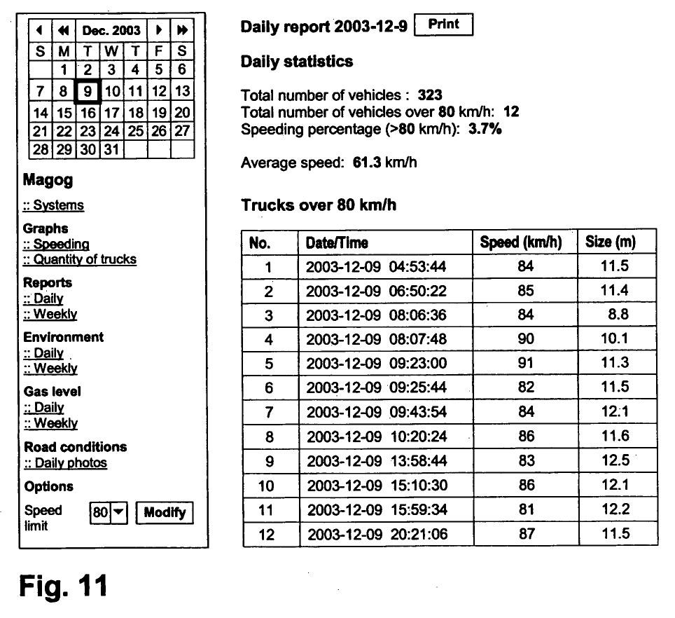

All information gathered by the detection system B of the present invention may be posted on a website, such that clients may remotely consult the website to obtain information pertaining to the detection points. Moreover, in view of the available information, road traffic controllers can suggest different courses to a fleet of drivers to avoid bad road conditions. For instance, in FIG. 8, a web page illustrating a map upon which are positioned detection apparatuses is generally shown at 90. Upon clicking on some of the points representing apparatus sites, information web pages, such as those illustrated in FIGS. 9 to 11, are reached.

The multiple functions and data-gathering components of the detection system of the present invention will enable road traffic controllers to know, in a short amount of time, the road conditions at many points by way of the collection of data from the detection system B. It is pointed out that a plurality of the detection apparatus A may be used over a territory to provide multiple data collection points.

1. A method for signaling speed derogations to a vehicle driver in road traffic, comprising the steps of:
i) monitoring a road to detect movement caused by a vehicle;
ii) measuring a speed of the vehicle detected in step i); and
iii) signaling a warning if the speed is above a given value.

2. The method according to claim 1, wherein the step iii) of signaling is performed by emitting a flashing light signal.

3. The method according to claim 2, wherein the flashing light signal simulates a police car light emission.

4. The method according to claim 1, wherein the step ii) further comprises collecting data associated to the vehicle, said data being a length of the vehicle.

5. The method according to claim 1, wherein the step ii) further comprises collecting data associated to the time and date at which the speed of the vehicle is detected.

6. The method according to claim 1, wherein the step ii) further comprises collecting data associated to the surroundings of the vehicle, said data being at least one of pavement conditions and environmental conditions.

7. A system for detecting road traffic conditions and environmental conditions, comprising:
at least one detection apparatus comprising sensors for detecting any one of road traffic conditions and environmental conditions, the at least one detection apparatus being adapted to be located at a surveillance site, the at least one detection apparatus having a processing unit so as to interpret information collected by any one of the sensors;
a telecommunications device connected to the apparatus so as to transmit data interpreted by the at least one detection apparatus to a remote server; and
the remote server for receiving said data from the at least one detection apparatus, the remote server being accessible to provide the data collected by the at least detection apparatus.

8. The system according to claim 7, wherein one of said sensors is a radar for scanning vehicle speed, the at least one detection apparatus having a light emitting device to indicate a speeding derogation in response to an interpretation from the processing unit of the at least detection apparatus.

9. The system according to claim 7, wherein the sensors have any one of a humidity level sensor, a noxious gas level sensor and a temperature sensor.

10. The system according to claim 7, wherein any one of the sensors is a surveillance camera so as to obtain images at the surveillance site.

11. The system according to claim 8, wherein the light emitting device simulates a police car light emission.

12. The system according to claim 7, wherein the sensors have a sound level sensor.
